(19) United States
(12) Patent Application Publication
(10) Pub. No.: US 2020/0130638 A1
(43) Pub. Date: Apr. 30, 2020

(54) BUCKLE DEVICE

(71) Applicant: KABUSHIKI KAISHA TOKAI-RIKA-DENKI-SEISAKUSHO, Aichi-ken (JP)

(72) Inventors: Shota FUTAMURA, Aichi-ken (JP); Tomoyuki HORIYAMA, Aichi-ken (JP)

(21) Appl. No.: 16/655,435

(22) Filed: Oct. 17, 2019

(30) Foreign Application Priority Data
Oct. 24, 2018 (JP) 2018-200205

(51) Int. Cl. B60R 22/26; A44B 11/00

(52) U.S. Cl. CPC B60R 22/26; B60R 2022/1806; B60R 2022/266; A44B 11/006

(57) ABSTRACT

Provided is a buckle device including: an anchor member that is attached to a vehicle; a buckle main body to which a tongue attached to a webbing for occupant restraint becomes fastened; a coupling member that is flexible and couples the buckle main body and the anchor member to each other; a support member that is formed in a tubular shape and in which the anchor member, the buckle main body, and the coupling member are housed; and contact portions that are provided on the support member and with which the support member supports the buckle main body with respect to the anchor member in a state in which the contact portions contact, in the thickness direction of the anchor member, one side portion and another side portion of the anchor member.

### CROSS-REFERENCE TO RELATED APPLICATION

This application is based on and claims priority under 35 USC 119 from Japanese Patent Application No. 2018-200205 filed on Oct. 24, 2018, the disclosure of which is incorporated by reference herein.

### BACKGROUND

### Technical Field

The present disclosure relates to a buckle device in which a tongue becomes fastened to a buckle main body.

### Related Art

Japanese Patent Application Laid-open (JP-A) No. 2006-213200 discloses a buckle device where a belt couples a plate anchor and a buckle main body to each other, the plate anchor, the buckle main body, and the belt are housed in a boot, and the boot supports the buckle main body with respect to the plate anchor.

In this connection, it is preferred that this kind of buckle device be able to inhibit tilting of the belt and the buckle main body in the thickness direction of the plate anchor.

### SUMMARY

The present disclosure has been made in view of the above circumstances, and it is an object thereof to provide a buckle device that can inhibit tilting of a coupling member and a buckle main body in the thickness direction of an anchor member.

A buckle device of a first aspect of the disclosure includes: an anchor member that is attached to a vehicle; a buckle main body to which a tongue attached to a webbing for occupant restraint becomes fastened; a coupling member that is flexible and couples the buckle main body and the anchor member to each other; a support member that is formed in a tubular shape and in which the anchor member, the buckle main body, and the coupling member are housed; and contact portions that are provided on the support member and with which the support member supports the buckle main body with respect to the anchor member in a state in which the contact portions contact, in the thickness direction of the anchor member, one side portion and another side portion of the anchor member.

A buckle device of a second aspect is the buckle device of the first aspect, further including a limiting portion that is provided inside the support member and limits the buckle main body and the anchor member from moving toward each other.

A buckle device of a third aspect is the buckle device of the first aspect or the second aspect, wherein the contact portions contact, in the thickness direction of the anchor member, at least one of the one side portion or the other side portion of the anchor member at plural places.

A buckle device of a fourth aspect is the buckle device of any one of the first to third aspects, wherein the contact portions contact the anchor member from one side thereof and another side thereof.

A buckle device of a fifth aspect is the buckle device of any one of the first to fourth aspects, further including a narrow portion that is provided in the support member, is disposed more on the anchor member side than the buckle main body, and reduces the interior cross section of the support member.

A buckle device of a sixth aspect is the buckle device of the fifth aspect, wherein the narrow portion increases the circumferential direction length of the support member.

A buckle device of a seventh aspect is the buckle device of any one of the first to sixth aspects, wherein the contact portions clamp the anchor member with elastic force, whereby the support member stands on its own with respect to the anchor member.

In the buckle device of the first aspect, the tongue attached to the webbing for occupant restraint becomes fastened to the buckle main body. Furthermore, the anchor member is attached to the vehicle, the coupling member couples the buckle main body and the anchor member to each other, and the coupling member is flexible. Moreover, the anchor member, the buckle main body, and the coupling member are housed in the tubular support member.

Here, the support member supports the buckle main body with respect to the anchor member in a state in which the contact portions of the support member contact, in the thickness direction of the anchor member, the one side portion and the other side portion of the anchor member. For this reason, tilting of the coupling member and the buckle main body in the thickness direction of the anchor member can be inhibited by the contact portions.

In the buckle device of the second aspect, the limiting portion inside the support member limits the buckle main body and the anchor member from moving toward each other. For this reason, the support member can appropriately support the buckle main body with respect to the anchor member.

In the buckle device of the third aspect, the contact portions contact, in the thickness direction of the anchor member, at least one of the one side portion and the other side portion of the anchor member at plural places. For this reason, tilting of the coupling member and the buckle main body in the thickness direction of the anchor member can be effectively inhibited.

In the buckle device of the fourth aspect, the contact portions contact the anchor member from the one side thereof and the other side thereof. For this reason, movement of the coupling member and the buckle main body toward the one side and the other side can be inhibited.

In the buckle device of the fifth aspect, the narrow portion of the support member is disposed more on the anchor member side than the buckle main body and reduces the interior cross section of the support member. For this reason, the narrow portion can limit the buckle main body from moving toward the anchor member.

In the buckle device of the sixth aspect, the narrow portion increases the circumferential direction length of the support member. For this reason, the interior cross section of the support member can be easily widened because of the narrow portion.

In the buckle device of the seventh aspect, the contact portions clamp the anchor member with elastic force, whereby the support member stands on its own with respect to the anchor member. For this reason, tilting of the coupling member and the buckle main body in the thickness direction of the anchor member can be effectively inhibited by the contact portions.

### BRIEF DESCRIPTION OF THE DRAWINGS

An exemplary embodiment of the present disclosure will be described in detail based on the following figures, wherein:

FIG. 1 is a front view showing the general configuration of a buckle device pertaining to the embodiment;

FIG. 2 is a plan view of an anchor;

FIG. 3 is a sectional view, seen from the side, of main portions of the buckle device;

FIG. 4A is a front view of an inner boot;

FIG. 4B is a back view of the inner boot;

FIG. 4C is a general sectional view, seen in the up and down direction, of a support portion of the inner boot;

FIG. 5A is a general sectional view, seen from below, of main portions of the inner boot; and

FIG. 5B is a general sectional view, seen from the front, of main portions of the inner boot.

### DETAILED DESCRIPTION

An embodiment of the disclosure will now be described in detail below with reference to the drawings.

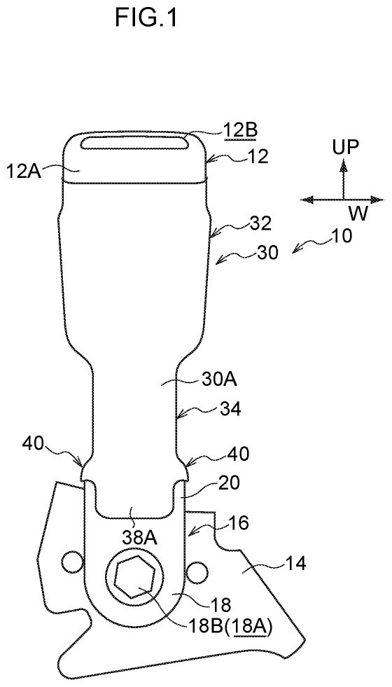

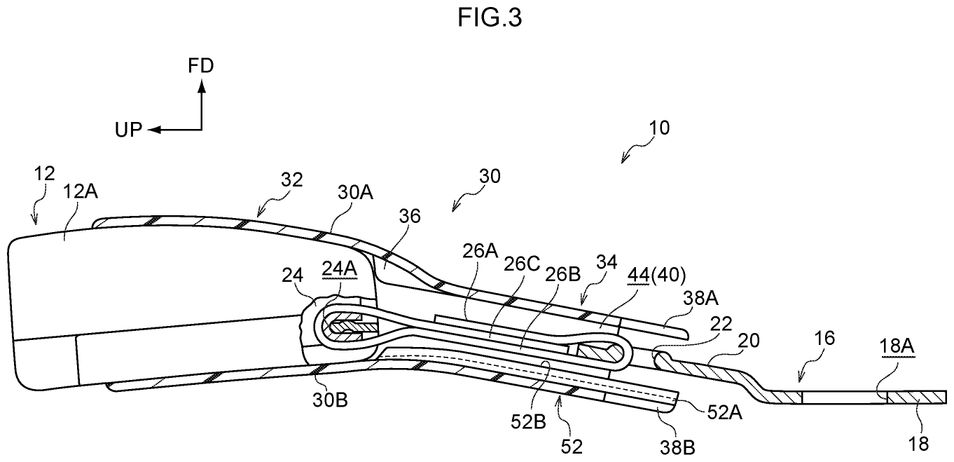

A buckle device 10 pertaining to this embodiment is attached to a seat (particularly a rear seat) in a vehicle cabin. In FIG. 1 the buckle device 10 pertaining to this embodiment is shown in a front view seen from inside in the vehicle width direction, and in FIG. 3 main portions of the buckle device 10 are shown in a sectional view seen from the side. In the drawings, the device front direction is indicated by arrow FD, the device width direction is indicated by arrow W, and the upward direction is indicated by arrow UP.

As shown in FIG. 1 and FIG. 3, the buckle device 10 has a block-shaped buckle main body 12. The buckle main body 12 is disposed on the vehicle width direction inner side of the seat in the cabin and is disposed so that its upper portion is exposed above the seat (not shown in the drawings). The buckle device 10 (the buckle main body 12) is disposed so that its width direction is aligned with the vehicle front and rear direction, its front side is on the opposite side (the vehicle width direction inner side), in the vehicle width direction, of an occupant seated in the seat, and its back side on the opposite side of the front side is on the occupant side (the vehicle width direction outer side).

The buckle main body 12 has a casing 12A in the upper portion of which is formed an insertion opening (tongue insertion opening) 12B, and a tongue not shown in the drawings is configured to be fastenable in and unfastenable from (insertable into and removable from) the insertion opening 12B. A long band-like seat belt (webbing) for occupant restraint is movably inserted through the tongue, and the occupant seated in the seat fastens the seat belt by inserting (fastening) the tongue into the buckle main body 12, whereby the seat belt becomes capable of restraining the occupant. When the tongue is removed (unfastened) from the buckle main body 12, the seat belt becomes unfastened from the occupant.

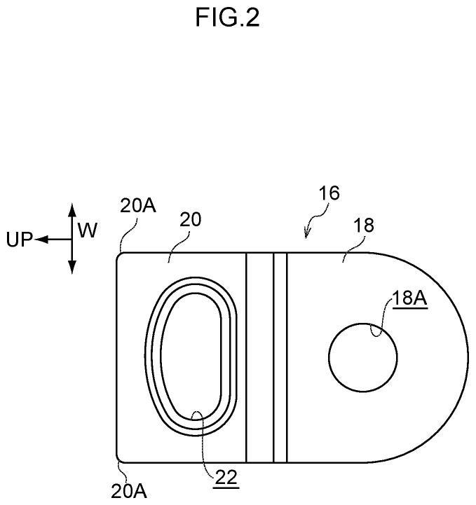

A tabular bracket 14 made of metal is attached to the floor (vehicle body) of the cabin in the vicinity of the seat (not shown in the drawings) or to a frame of the seat installed on the floor, and an anchor (anchor plate) 16 made of metal and serving as an anchor member is anchored to the bracket 14. In FIG. 2 the anchor 16 is shown in a plan view seen from the front.

As shown in FIG. 2, the anchor 16 is formed in a substantially rectangular shape, with one side thereof in its longitudinal direction (the lower side in the up and down direction) being configured to serve as a base portion 18 and the other side in its longitudinal direction being configured to serve as a coupling portion 20. The base end portion of the base portion 18 is formed in a semicircular shape, and a circular anchoring hole 18A whose center coincides with the center of the semicircle of the base end is formed through the base portion 18. The width direction of the anchor 16 is substantially aligned with the vehicle front and rear direction, and the anchor 16 is attached to the bracket 14 by a bolt 18B (see FIG. 1) inserted through the anchoring hole 18A in the base portion 18.

The distal end portion (upper portion) of the coupling portion 20 of the anchor 16 is formed in a rectangular shape. Corner portions 20A on both width direction sides of the distal end portion of the coupling portion 20 are formed in substantially right angles (substantially without roundness) as seen from the front and as seen from the side, and the roundness (radius R) of the corner portions 20A is configured to be the smallest manufacturable roundness (roundness with the smallest radius R). A long substantially elliptical coupling hole 22 whose longitudinal direction is aligned with the width direction of the anchor 16 is formed through the coupling portion 20.

As shown in FIG. 3, a buckle body 24 (partially shown in FIG. 3) is attached inside the casing 12A to the buckle main body 12, and the tongue that becomes fastened to the buckle main body 12 becomes engaged with the buckle body 24. A substantially elliptical coupling hole 24A that is long in the device width direction is formed through the buckle body 24.

The buckle device 10 is provided with a long band-like belt 26 that is flexible and serves as a coupling member. The belt 26 is formed of chemical fiber, for example. The width direction of the belt 26 is aligned with the device width direction. One longitudinal direction side portion 26A of the belt 26 is inserted and looped through the coupling hole 22 in the anchor 16 and is folded back at the position where it is looped through the anchor 16 (the coupling hole 22), so that the one longitudinal direction side portion 26A and a longitudinal direction middle portion 26B of the belt 26 overlie each other. Another longitudinal direction side portion 26C of the belt 26 is inserted and looped through the coupling hole 24A in the buckle body 24 and is folded back at the position where it is looped through the buckle body 24, so that the other longitudinal direction side portion 26C lies between the one longitudinal direction side portion 26A and the longitudinal direction middle portion 26B.

The one longitudinal direction side portion 26A, the longitudinal direction middle portion 26B, and the other longitudinal direction side portion 26C of the belt 26 are sewn together where they overlie each other. Because of this, in the buckle device 10, the buckle main body 12 and the anchor 16 are coupled to each other by the belt 26, and the buckle main body 12 is installed in the vehicle body via the anchor 16.

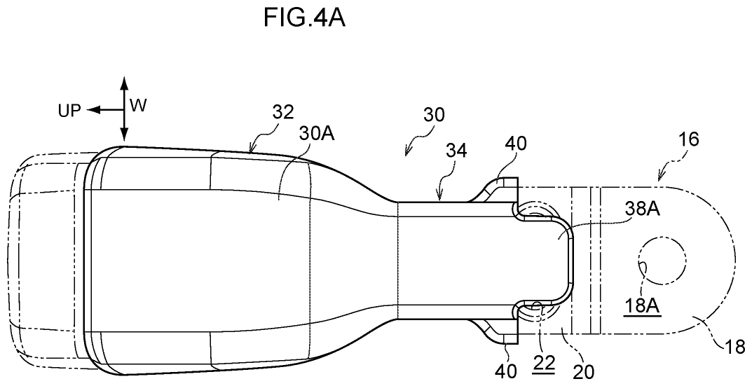

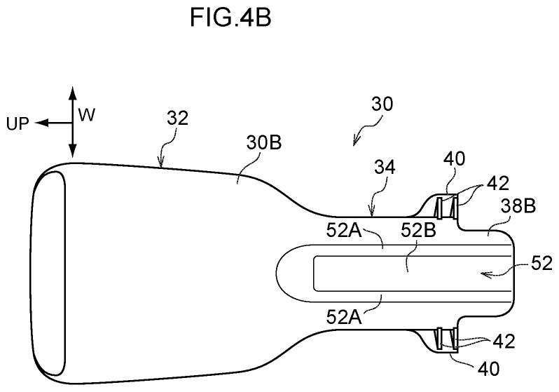

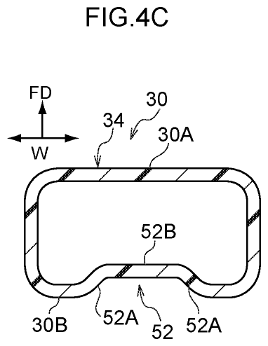

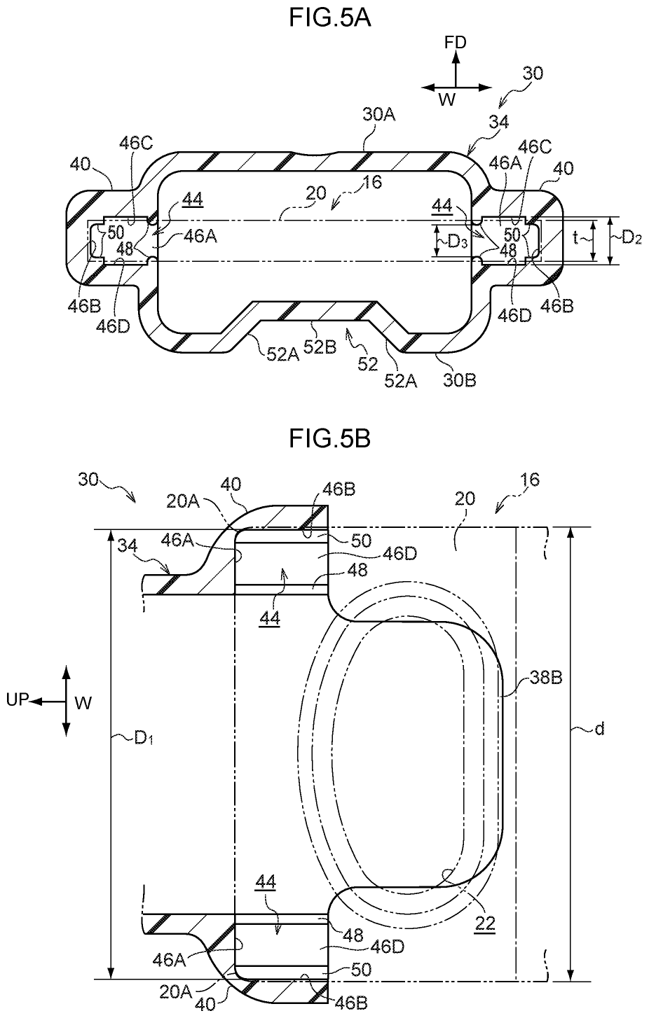

The buckle device 10 has an inner boot (belt inner boot) 30 serving as a support member. In FIG. 4A the inner boot 30 is shown in a front view seen from its front side (vehicle width direction inner side), in FIG. 4B the inner boot 30 is shown in a back view seen from its back side (vehicle width direction outer side), and in FIG. 4C main portions of the inner boot 30 are shown in a sectional view seen from above. Furthermore, in FIG. 5A main portions of the inner boot 30 are shown in a sectional view seen from below, and in FIG. 5B main portions of the inner boot 30 are shown in a sectional view seen from the front.

As elastomer serving as a soft resin and an elastic resin (elastic material) is used for the inner boot 30, and the inner boot 30 is flexible and elastic (has rubber elasticity). As shown in FIG. 3 and FIG. 4A to FIG. 4C, the inner boot 30 is formed in a tubular shape with a substantially rectangular cross section overall, and the inner boot 30 bridges the buckle main body 12 and the anchor 16 in a state in which it houses the belt 26.

One side (the upper side) of the inner boot 30 in the longitudinal direction thereof is configured to serve as a housing portion 32, and the other side (the lower side) of the inner boot 30 in the longitudinal direction thereof is configured to serve as a support portion 34. The end (upper end) of the inner boot 30 on the housing portion 32 side and the end (lower end) of the inner boot 30 on the support portion 34 side are open, and these openings communicate with each other all the way through the interior of the inner boot 30 from the housing portion 32 to the support portion 34.

The inside of the housing portion 32 is open to allow insertion of the lower-side portion of the buckle main body 12 therein, and the inside of the support portion 34 is open to allow the belt 26 to be housed therein. Furthermore, the size of the interior cross section of the support portion 34 is configured to be smaller (narrower) than the interior cross section of the housing portion 32. In the inner boot 30, the lower portion of the housing portion 32 gradually narrows in width heading toward the support portion 34 side as seen in a front view, and as seen in a side view a front portion 30A of the inner boot 30 curves toward a back portion 30B of the inner boot 30 heading toward the support portion 34 side.

The inner circumference of the housing portion 32 (the inner circumference at a cross section along a direction intersecting the longitudinal direction) is configured to be shorter than the outer circumference of the buckle main body 12 (the outer circumference at a cross section along a direction intersecting the longitudinal direction), and the size of the opening of the housing portion 32 is configured to be smaller than the outer shape of the buckle main body 12. Because of this, the housing portion 32 becomes enlarged when the buckle main body 12 is housed therein, and the buckle main body 12 is housed inside the housing portion 32 in a state in which it is clamped by elastic force.

As shown in FIG. 3, on the support portion 34 side of the housing portion 32, plural ribs 36 that configure a limiting portion are formed on the inner surface of the front portion 30A, and the plural ribs 36 are arrayed in the device width direction (the vehicle front and rear direction) of the housing portion 32. Each of the ribs 36 projects from the inner surface of the front portion 30A toward the back portion 30B and upward (toward the opening in the upper portion), and the upper end of each of the ribs 36 opposes the lower end of the casing 12A of the buckle main body 12. Ends (end faces) of the ribs 36 on the back portion 30B side are configured to be substantially flush with the inner surface of the front portion 30A at the support portion 34. Because of this, the buckle main body 12 housed inside the housing portion 32 is limited from moving downward with respect to the inner boot 30.

The inner boot 30 is configured to have a length wherein the distal end portion of the coupling portion 20 of the anchor 16 is housed in the lower end portion of the support portion 34 in a state in which the lower portion of the buckle main body 12 is housed inside the housing portion 32. Tongue piece portions 38A, 38B are formed on the lower end portion of the support portion 34. The tongue piece portion 38A extends from the front portion 30A, and the tongue piece portion 38B extends from the back portion 30B. Because of this, the tongue piece portions 38A, 38B are configured to be elastically deformable in directions in which the sides thereof on the opposite side of the support portion 34 side move toward and away from each other. The coupling hole 22 in the coupling portion 20 of the anchor 16 and the area around the coupling hole 22 are covered by the pair of tongue piece portions 38A, 38B.

Anchor gripping portions 40 serving as contact portions are formed on the lower portion of the inner boot 30. As shown in FIG. 5A and FIG. 5B, the anchor gripping portions 40 are configured in the shape of substantially rectangular blocks and project from both sides of the lower end portion of the support portion 34 in the device width direction (the vehicle front and rear direction). On the back portion 30B side of the support portion 34, ribs 42 are formed between the back portion 30B and the anchor gripping portions 40, and the anchor gripping portions 40 are reinforced, and limited from swinging in the vehicle width direction, by the ribs 42.

A hollow pocket portion 44 is formed inside each of the anchor gripping portions 40, and the pocket portions 44 open to the support portion 34 interior and downward. Each of the pocket portions 44 has an interior face 46A on the upper side, a side face 46B in the device width direction, an opposing face 46C on the front side, and an opposing face 46D on the back side. The interior face 46A, the side face 46B, the opposing face 46C, and the opposing face 46D are each formed in a substantially rectangular shape, and the angles at which they intersect each other are configured to be substantially right angles. The inner surface of the corner portion between the interior face 46A and the side face 46B has a roundness whose inner radius R is the smallest manufacturable.

A distance D1 between the side faces 46B of the pair of pocket portions 44 is configured to be slightly smaller than a width dimension d of the anchor 16 (the coupling portion 20) (D1<d). Furthermore, a distance D2 between the opposing face 46C and the opposing face 46D in each of the pocket portions 44 is configured to be slightly larger than a thickness t of the distal end of the coupling portion 20 of the anchor 16 (D2 >t). Because of this, the pocket portions 44 are configured as cuboidal spaces, and the distal end portion of the anchor 16 (the distal end portion of the coupling portion 20) bridges, and is insertable and disposable between, the pair of pocket portions 44. Furthermore, each of the corner portions 20A of the distal end of the anchor 16 is insertable into each of the pair of pocket portions 44.

The interior faces 46A in the anchor gripping portions 40 configure the limiting portion together with the ribs 36 inside the housing portion 32, and when the distal end (end face) of the anchor 16 inserted inside the pocket portions 44 abuts against the interior faces 46A, the anchor 16 is limited from moving upward with respect to the inner boot 30.

Plural pairs of projecting portions (in this embodiment, two pairs each of projecting portions 48, 50) are provided inside the anchor gripping portions 40 (the pocket portions 44). The projecting portions 48 project inside the pocket portions 44 (in directions toward each other) on the support portion 34 side of each of the opposing faces 46C, 46D, and the projecting portions 50 project in directions toward each other on the side face 46B side end of each of the opposing faces 46C, 46D.

A distance D3 between the projecting distal ends of the projecting portions 48, 50 is configured to be smaller than the thickness t of the distal end portion of the anchor 16 (D3<t<D2). Because of this, when the anchor 16 is inserted and disposed inside the pocket portions 44 of the anchor gripping portions 40, the side faces 46B come into contact with and push against both width direction end faces of the anchor 16, thereby limiting movement of the anchor 16 in the device width direction with respect to the inner boot 30. Furthermore, the projecting portions 48, 50 contact the anchor 16 at two places each in the width direction. Because of this, the anchor 16 is sandwiched and held at two places each in the width direction by the projecting portions 48, 50 and is held by the support portion 34.

A narrow portion 52 is formed in the support portion 34 of the inner boot 30. The narrow portion 52 is formed, ranging from the housing portion 32 side to the tongue piece portion 38B, in the back portion 30B of the support portion 34. The narrow portion 52 is configured by a sloping portion 52A that slopes from the back portion 30B toward the support portion 34 interior and a planar portion 52B that interconnects distal end portions of the sloping portion 52A.

Because of this, the narrow portion 52 forms a furrow-like sunken portion in the outer side of the back portion 30B of the inner boot 30 and forms a ridge-like raised portion on the inner side of the back portion 30B of the inner boot 30. The interior of the support portion 34 of the inner boot 30 is reduced by the narrow portion 52, and the narrow portion 52 limits oscillation of the belt 26 housed inside the support portion 34. Because the narrow portion 52 is formed, the length of the support portion 34 around its cross section in a direction intersecting its longitudinal direction is increased in comparison to a case where the narrow portion 52 is not formed.

Next, the action of this embodiment will be described.

In the buckle device 10 of the above configuration, the buckle main body 12 and the anchor 16 are coupled to each other by the belt 26, and the buckle main body 12 is disposed in the vehicle body by attaching the anchor 16 to the bracket 14. Furthermore, the inner boot 30 in which the belt 26 is housed bridges the buckle main body 12 and the anchor 16, with the belt 26 being housed in the inner boot 30 and with the lower portion of the buckle main body 12 and the distal end portion of the anchor 16 being housed in the inner boot 30.

Here, the inner boot 30 is elastic, and the interior cross sections of the housing portion 32 and the support portion 34 are extensible. For this reason, the interior cross section of the support portion 34 of the inner boot 30 can be easily widened, and by widening the interior cross section of the support portion 34, the buckle main body 12 becomes insertable therein. Because of this, the buckle main body 12 can be inserted from the support portion 34 into the housing portion 32, so the inner boot 30 can be disposed bridging the buckle main body 12 and the anchor 16. Consequently, in the buckle device 10, the assembly of the inner boot 30 becomes easy, and the assembly workability of the inner boot 30 is improved.

Furthermore, the pair of anchor gripping portions 40 are integrally formed on the support portion 34 of the inner boot 30, and the distal end portion of the coupling portion 20 of the anchor 16 is fitted into the pocket portions 44 inside the anchor gripping portions 40. The projecting portions 48, 50 are formed inside each of the anchor gripping portions 40 in the width direction of the anchor 16, and the projecting portions 48, 50 contact the anchor 16 in its thickness direction. For this reason, the inner boot 30 can be inhibited from tilting in the thickness direction of the anchor 16. Moreover, in each of the anchor gripping portions 40, the projecting portions 48, 50 sandwich, hold, and clamp with elastic force the anchor 16 in its thickness direction. Because of this, the anchor 16 is held in the thickness direction of the anchor 16 by each of the anchor gripping portions 40, the anchor 16 can appropriately allow the inner boot 30 to stand on its own, and the self-standing inner boot 30 can appropriately support the buckle main body 12 and the belt 26.

Moreover, the projecting portions 48, 50 contact the anchor 16 in its thickness direction at two places each in its width direction. Because of this, the anchor gripping portions 40 can effectively clamp, in the thickness direction of the anchor 16, the width direction end portions of the anchor 16.

Furthermore, the anchor gripping portions 40 sandwich and hold the anchor 16 in its thickness direction on both device width direction sides of the support portion 34. For this reason, the anchor gripping portions 40 are inhibited from flexing about the up and down direction with respect to the inner boot 30. Because of this, the inner boot 30 is prevented by the anchor 16 from twisting about the up and down direction, so the inner boot 30 is improved in autonomy and can stably support the buckle main body 12 and the belt 26.

Furthermore, the anchor 16 is clamped in its width direction between the side faces 46B of the pair of anchor gripping portions 40 (it suffices for it to be contacted in its width direction). For this reason, the inner boot 30 is inhibited from tilting in the device width direction with respect to the anchor 16, so the inner boot 30 can properly stand on its own and can support the buckle main body 12 and the belt 26.

Moreover, inside the anchor gripping portions 40, the interior faces 46A and the side faces 46B are disposed at substantially right angles to each other. For this reason, the corner portions 20A of the anchor 16 abut against the interior faces 46A and the side faces 46B, so the inner boot 30 can be effectively inhibited from tilting in the device width direction with respect to the anchor 16. Moreover, the corner portions 20A of the coupling portion 20 are configured to have the minimum roundness, and the inner surfaces of the corner portions between the interior faces 46A and the side faces 46B of the pocket portions 44 are configured to have the minimum roundness, so the interior faces 46A and the side faces 46B of the pocket portions 44 closely adjoin the surfaces of the coupling portion 20 located in directions intersecting the thickness direction of the coupling portion 20. For this reason, the inner boot 30 can be more effectively inhibited from tilting in the device width direction with respect to the anchor 16.

Furthermore, the tongue piece portions 38A, 38B extending from the lower end portion of the support portion 34 of the inner boot 30 cover both vehicle width direction sides of the coupling portion 20 of the anchor 16. For this reason, when the inner boot 30 tilts in the device width direction with respect to the anchor 16, the tongue piece portions 38A, 38B abut against the coupling portion 20, generating restoring force in the inner boot 30, so tilting of the inner boot 30 in the vehicle width direction can be more effectively inhibited.

Consequently, by providing the anchor gripping portions 40 on the inner boot 30, the inner boot 30 supported by the anchor 16 can be effectively inhibited from tilting, and the autonomy of the inner boot 30 is effectively improved. Moreover, if the anchor 16 were sandwiched by the opposing faces 46C, 46D, frictional force would increase and the assemblability of the inner boot 30 would be impaired, but with the anchor gripping portions 40, the anchor 16 is sandwiched and held by each of the projecting portions 48, 50, so there is less friction and assemblability can be inhibited from being impaired.

The inner boot 30 is provided with the ribs 36 that oppose the lower end of the buckle main body 12 inside the housing portion 32, and the ribs 36 abut against the buckle main body 12, thereby limiting the buckle main body 12 from moving downward inside the inner boot 30. Furthermore, the distal end of the anchor 16 abuts against the interior faces 46A inside the anchor gripping portions 40, thereby limiting the anchor 16 from moving upward inside the inner boot 30.

For this reason, the buckle main body 12 and the anchor 16 are limited from moving toward each other inside the inner boot 30, and the occurrence of slack and deflection in the inner boot 30 due to the buckle main body 12 and the anchor 16 moving toward each other is inhibited. Because of this, the autonomy of the inner boot 30 can be effectively ensured.

Furthermore, the buckle main body 12 and the anchor 16 are coupled to each other by the belt 26. For this reason, movement of the buckle main body 12 in the direction in which it comes out of the inner boot 30 (upward) can be limited by the anchor 16, and movement of the anchor 16 in the direction in which it comes out of the inner boot 30 (downward) can be limited by the buckle main body 12. Because of this, shifting can be inhibited from occurring between the inner boot 30 and the buckle main body 12 and between the inner boot 30 and the anchor 16.

Moreover, shifting is inhibited from occurring in the inner boot 30 between the ribs 36 and the interior faces 46A of the anchor gripping portions 40, so shifting and riding-up can be inhibited from occurring in the inner boot 30 (the front portion 30A) on the upper side of the ribs 36. Because of this, the inner boot 30 can be inhibited from shifting and ending up moving downward with respect to the buckle main body 12.

Moreover, in the inner boot 30, the narrow portion 52 is provided in the support portion 34 on the lower side of the buckle main body 12. The interior cross section of the support portion 34 of the inner boot 30 in the direction intersecting the up and down direction is configured to be a closed cross section, and the narrow portion 52 projects into the closed cross section. Because of this, the buckle main body 12 can be effectively limited by the narrow portion 52 from moving toward the anchor 16.

Furthermore, the narrow portion 52 increases the length of the outer peripheral portion, about the up and down direction, of the support portion 34 of the inner boot 30. For this reason, the support portion 34 more easily extends in its circumferential direction, so it becomes easier for the interior cross section of the support portion 34 to be widened by elastic deformation to insert the buckle main body 12. Because of this, the assembly of the inner boot 30 becomes easier and the assemblability of the inner boot 30 can be further improved.

As described above, in the buckle device 10 pertaining to this embodiment, by using an elastic material for the inner boot 30, the workability of the work of assembling the inner boot 30 is improved. Furthermore, the anchor gripping portions 40 are provided on the inner boot 30, and both width direction sides of the anchor 16 are sandwiched and held by the anchor gripping portions 40, so the autonomy of the inner boot 30 supported by the anchor 16 can be ensured.

In this embodiment, the long band-like belt 26 is used as the coupling member, but a wire or the like may also be used as the coupling member. Furthermore, in this embodiment, the anchor 16 is attached via the bracket 14 to the vehicle body, but the anchor member may also be directly attached to the vehicle body or the like.

Furthermore, in this embodiment, the anchor 16 is sandwiched and clamped in its thickness direction at the two places each of the projecting portions 48, 50 in the anchor gripping portions 40 serving as contact portions. However, the contact portions may also clamp the anchor member at one place or may also clamp the anchor member at three or more places. Furthermore, it suffices for the contact portions to contact the anchor member in its thickness direction.

What is claimed is:

1. A buckle device comprising:
an anchor member that is attached to a vehicle;
a buckle main body to which a tongue attached to a webbing for occupant restraint becomes fastened;
a coupling member that is flexible and couples the buckle main body and the anchor member to each other;
a support member that is formed in a tubular shape and in which the anchor member, the buckle main body, and the coupling member are housed; and
contact portions that are provided on the support member and with which the support member supports the buckle main body with respect to the anchor member in a state in which the contact portions contact, in the thickness direction of the anchor member, one side portion and another side portion of the anchor member.

2. The buckle device according to claim 1, further comprising a limiting portion that is provided inside the support member and limits the buckle main body and the anchor member from moving toward each other.

3. The buckle device according to claim 1, wherein the contact portions contact, in the thickness direction of the anchor member, at least one of the one side portion or the other side portion of the anchor member at plural places.

4. The buckle device according to claim 1, wherein the contact portions contact the anchor member from one side thereof and another side thereof.

5. The buckle device according to claim 1, further comprising a narrow portion that is provided in the support member, is disposed more on the anchor member side than the buckle main body, and reduces the interior cross section of the support member.

6. The buckle device according to claim 5, wherein the narrow portion increases the circumferential direction length of the support member.

7. The buckle device according to claim 1, wherein the contact portions clamp the anchor member with elastic force, whereby the support member stands on its own with respect to the anchor member.

8. The buckle device according to claim 2, wherein the limiting portion includes a plurality of ribs formed on an inner surface of the support member.

9. The buckle device according to claim 8, wherein the plurality of ribs are arrayed in a device width direction of the support member.

10. The buckle device according to claim 9, wherein a plurality of pairs of projecting portions are provided in the contact portions.
